(19) United States
(12) Patent Application Publication
(10) Pub. No.: US 2011/0264550 A1
(43) Pub. Date: Oct. 27, 2011

(54) System for Developing Direct Relationships Between Service Providers and Consumers for the Healthcare and Other Privacy and Security sensitive Industries

(76) Inventor: Alex Fair, Garden City, NY (US)

(21) Appl. No.: 13/092,213

(22) Filed: Apr. 22, 2011

Related U.S. Application Data
(60) Provisional application No. 61/327,656, filed on Apr. 24, 2010.

(51) Int. Cl. G06Q 30/00

(52) U.S. Cl. 705/26.2

(57) ABSTRACT

A computerized system for developing online relationships between providers of services and people who need the services is described. The system aids providers of services (“Providers”) in developing offerings, contracts, customer bases, marketing programs, and reputations through automated systems and communications via an online internet enabled interface is described. Simultaneously, the system aids consumers of services in evaluating service providers, developing relationships with them, and negotiating mutually agreeable service contracts while controlling privacy. The particular application used to describe the invention is for the healthcare industry but the same hardware, software, processes and systems is designed to be applied to any service industry where security and privacy are concerns.

### CROSS REFERENCE TO RELATED APPLICATIONS

This application claims the benefit of U.S. provisional patent application Ser. No. 61/327,656 filed on Apr. 24, 2010, which is incorporated herein by reference.

### FIELD OF THE INVENTION

The present invention relates to the field of direct relationship development between providers and consumers in an online environment, with particular use in the healthcare industry.

### BACKGROUND

Whether individuals are shopping for a new mechanic for a car or a new dentist, it is difficult to consistently find one that will treats an individual consumer well or charges fairly. The complexity of the relationship between providers of services that are of critical importance to consumers is such that individuals generally only select such important providers on the recommendation of trusted friends or family members. As the number and specialization of such providers increases, the likelihood that a consumer's network of trusted individuals contains all of the providers needed diminishes. To date there has been no single system that respects the complexity of these critical service provider/consumer relationships and automates relationship building in a manner that respects both Providers of critical services (“Providers”) and those who need their services. One area of particular complexity has been the medical and healthcare provider field as prices and services have been disjointed, inconsistent, and consumers have often been without an understanding of the pricing for services.

### SUMMARY

To overcome these issues, the present invention is a computerized system for initiating, establishing and cultivating direct relationships between service providers and consumers. The first application of the system described in this patent application (“The System”) is tailored for the healthcare industry where the relationship between doctors and patients is rarely built on direct communication, detailed service offerings with prices, or verified service-level reviews and there is a great need for improvement. Privacy concerns, payment and pricing models, service agreements, communications, Provider marketing, and Provider reputation management communications all require a unique approach that respects and addresses the needs of this interaction. To address these requirements a system has been developed that is unlike previous inventions that negotiate prices, advertise, market, or manage communications. Here is described a unique integrated system whereby people and providers don't just arrange for medical care but they build relationships and change the paradigm of healthcare delivery. Providers don't just advertise, they engage and interact with their patients and the public in ways they never could previously. The system of the invention improves how people and providers of critically important services meet and agree upon services, much desired an upgrade over the “word of mouth” recommendations of the past.

The system includes a consumer or patient connected to the Internet via a computer device, such as a laptop or one of various wireless hand held type devices. The patient uses the system to search for care providers by entering desired search information into his or her computer device. The patient's requests are sent via the Internet to a server with its affiliated hardware and software, relational database and security/privacy features. Similarly, the provider is connected to the Internet via the provider's computer or mobile access devices. The provider uses the system to search for patients or offer care by entering information on their services into the system via the provider's computer. The system includes a Private Personal Profile for the patient, a matching combination feature to match consumers/potential patients with care providers to create a successful contract where an offer and request are matched (“Done Deals”). From a successful contract, the consumer/patient and provider arrange the onsite meeting or office visit where care services are provided and payment is made. Afterward, the system includes a feature of a review system, called an “Offer Specific Verified Review,” to allow feedback from patients on specific offers of service providers who used the system, with the review information sent back for storage in databases at servers. The system also allows for a matching process between consumer/patient and provider when there are no exact matching combinations based on patients and providers information in the system's databases and servers The system then allows for modified or new requests to be sent to relevant providers for offers not in the system.

With the present invention, there is provided a system which is used in a computer network having numerous consumers/users, service providers and corresponding individual computers or wireless online computing devices for each. The system includes a first computing device with a first user communicating with a second computing device and a first service provider through a server where the user has the ability to selectively control the privacy of communications with the system. The first computing device receives a user pricing request for services from the first user, and a data storage device associated with the server has a plurality of provider offers from a plurality of service providers. In the system, each of the plurality of provider offers have a list price value, a low acceptable price value less than the list price, and a rejection price value less than the low acceptance price value. When the first user price request has a value greater than or equal to the low acceptance price value of at least one of the plurality of service providers, the system returns at least one matching provider offer to the first user. The first user then selects one of the matching provider offers to establish a relationship and use the provider's services. If the user price request is below the acceptable price limit of the provider, but above the provider's hidden rejection price, a counter offer process for the provider to the user/consumer is initiated by the system.

The present invention also provides for a computer implemented method which can be used in a computer network having a multitude of consumers/users, service providers and corresponding individual computers or wireless online computing devices for each. The method includes a first user and a first computing device communicating with a second computing device and a first service provider through a server and receiving a user pricing request for services from the first user at the first computing device. The user in the method has the ability to selectively control the privacy of information communicated with the system. The method associates a data storage device with the server and communicates with the data storage device. The storage device and server maintains a plurality of provider offers from a plurality of service providers; each of the plurality of provider offers has a list price value, a low acceptable price value which is less than the list price, and a rejection price value which is less than the low acceptance price value. The method of the present invention then communicates the user price request to the storage device and server. When the price request has a value greater than or equal to the low acceptance price value of at least one of the plurality of service providers, the method returns those offers to the consumer as matching provider offers. The method then allows selection of one of the matching provider offers by the first user to initiate a user and provider relationship.

### BRIEF DESCRIPTION OF THE DRAWINGS

FIG. 1 provides an overview of the system of the present invention.

FIG. 2 illustrates an advanced care search screen for searching and matching providers and consumers.

FIG. 3 illustrates a search results screen displaying a typical search result with the present invention.

FIG. 4 illustrates a schematic of a feature of the present invention where providers can configure an offer of services.

FIG. 5a is a diagram of the private personal profile feature of the present invention.

FIG. 5b is an example of the privacy settings of the present invention.

FIG. 6 illustrates the pricing system for offerings of the present invention.

FIG. 7 is a schematic of the deal management console of the present invention.

FIG. 8 is a flow diagram of the deal making system between service providers and consumers of the present invention.

FIG. 9 is a sample output document of the system of the present invention.

FIG. 10 is a flow diagram of the offer/request and marketing system of the present invention.

FIG. 11 illustrates how consumers request new deals from service providers.

FIG. 12 is a flow diagram illustrating how providers market their services to consumers with the present invention.

FIG. 13 is a flow diagram of the offering specific verified review system of the present invention.

### DETAILED DESCRIPTION

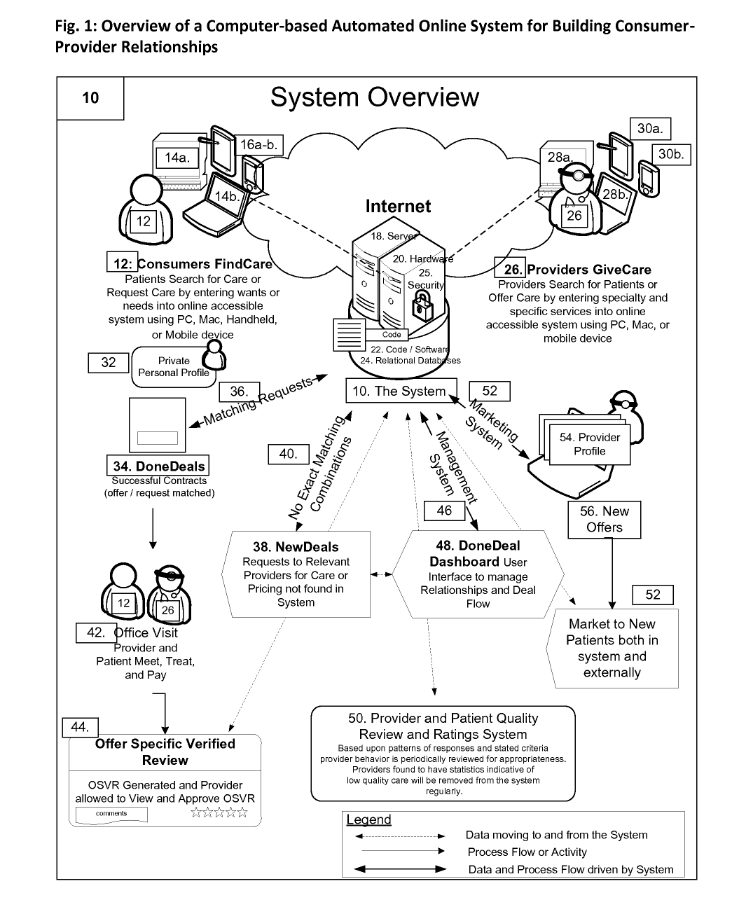

With reference to FIG. 1, the system of the present invention will be described. The system 10 includes a consumer or patient 12 connected to the Internet via a computer 14a, a laptop 14b, or one of various wireless hand held type devices 16a, 16b. The patient 12 uses the system 10 to search for care providers by entering information, such as their needs or wants for consumption, into his or her computer 14a, laptop 14b, or mobile handheld device 16a, 16b. The patient's requests are sent via the Internet to the server 18, with its affiliated hardware 20 and software 22, relational database 24 and security/privacy features 25. Similarly, provider 26 is connected to the Internet via the provider's computer 28a or laptop 28b or mobile access devices 30a, 30b. The provider uses the system 10 to search for patients 12 or offer care by entering information, such as specialty or services into the provider's computer 28a, laptop 28b, or mobile access device 30a, 30b. The system 10 includes a Private Personal Profile 32 for the patient 12, a matching combination feature 36 to match consumers/potential patients 12 with care providers 26 to create a successful contract 34 where an offer and request are matched (“Done Deals”). From a successful contract 34, the consumer/patient 12 and provider 26 arrange the onsite meeting or office visit 42 where care services are provided and payment is made. Afterward, the system 10 includes a feature of a review system 44, called an “Offer Specific Verified Review,” to allow feedback from patients 12 on specific offers of service providers 26 who used the system 10, with the review information sent back for storage in databases 24 at servers 18. Additionally, the system 10 allows for a matching process between consumer/patient 12 and provider 26 when there are no exact matching combinations 40 based on patients 12 and providers 26 information in the system's databases 24 and servers 18. The system 10 then allows for modified or new requests 38 to be sent to relevant providers 26 for offers not in the system 10.

The system includes a management system 46 which has a user interface 48 to manage relationships and deals (“DoneDeal Dashboard”). The system 10 also includes a provider and patient quality review system 50. Based upon patterns of responses and stated criteria, provider behavior is periodically reviewed for appropriateness. Providers 26 found to have statistics indicative of low quality care are removed from the system regularly. The information is sent back to storage at the database 24 and servers 18 for access by other users 12.

The system also includes a marketing system 52 which includes a provider profile 54, that receives data and information from the server 18 and database 24. The provider marketing system 52 allows modified or new offers 56 to be sent out to relevant consumers 12 through the servers 18, database 24 and the system 10 via the Internet connections between provider 26 and patient/consumers 12.

As illustrated by FIG. 1, the present invention 10 is a computer-based (14a, 14b, 28a, 28b) or hand held wireless device (16a, 16b, 30a, and 30b) online system 10 for consumers 12 to build and develop service provider 26 relationships, to give performance reviews 44, and to contract 34 with service providers 26. The invention is based on a system of computer hardware and software 18, 20, 22, 24, and 25 designed to solve the problems inherent in service provider relationship development in a novel way. As depicted in FIG. 1, there are two classes of users in the system 10, consumers 12 (or patients in this application of the invention 10), and providers 26, doctors generally in this case. Each of the consumers 12 and providers 26 is invited to enter certain information about their needs or services. The system 10, a complex technological creation of hardware, software, connectivity, and logic; then seeks to find the best matches for each stated service request or service offering based upon a complex algorithm. The system then facilitates and automates the development of contracts 34 between providers 26 and consumers 12 in a number of novel ways. An automated pricing and acceptance system, an automated contract generation tool, an automated service offering system, automated marketing systems 52, strict privacy controls, a verified offering specific review process 44, a contract/deal making management system 46, and an intelligent monitoring and reporting system 50 are all tightly integrated and wrapped in a security wrapper that prevents intrusion and abuse. Each sub-system 36, 40, 46, 52 is an operable component to the whole system design 10. Taken as a complete and integrated system, the invention is novel and a new tool that will aid consumers and providers in developing deep, successful, and mutually satisfying relationships with greater success than existing methods and systems allow.

The system enables open access to the general public to review the past work, quality metrics, verified customer testimonials, and service offerings with list prices for a range of providers. In order to enter requests or offers into the system users 12, 26 are required to enter certain information. For consumers this is called the Private Personal Profile or “PPP” 32. The PPP 32 allows individuals 12 to record certain information and only allow certain information to be made available to the providers of services 26 or other users or systems that are integrated with the system (Facebook, Twitter, LinkedIn, . . . ) Entering this data enables the consumer 12 to make requests and deals with providers 26 in the system 10. Next, the system 10 facilitates complete negotiations of service details and price with one or multiple providers via an integrated automated online application. Management 46 of these requests and offers for both consumers 12 and providers 26 goes through an interface 48 called the “DoneDealDashboard” and responses are sent between provider 26 and consumer 12 until either an agreement is reached or rejected. In the successful case the system 10 generates a document, appropriately named a “DoneDealDocument” and sends it electronically to both the provider 12 and consumer 16. A service visit 42 is scheduled and the consumer 12 is queried up to three times in the following weeks to review the service offering. This review activates the Offering Specific Verified Review (OSVR) sub-system 44. The OSVR data is compiled at server 18 and database 24, which is then utilized to generate metrics on providers 26 for the next consumers seeking similar deals.

From the perspective of the provider 26, the system 10 is analogous with a few changes. First contact with the system 10 will likely be a search for patients 12 seeking a given offering. Due to the privacy restrictions, providers 26 receive only limited information about the individuals 12 making such requests but will be capable of seeing what the local market seeks for care in their area of care giving interest. In order to acquire new customers 12, or patients in the case of healthcare, the provider 26 must register with the system 10. This registration requires the provider 12 to configure a profile which will help consumers 12 evaluate the provider's fitness for the particular service offerings. Next, the provider 26 can enter service offerings using the guided offering system. This system, called the Easy Offering Creator, allows the provider 26 to create service offerings based upon templates quickly and effectively. It also allows providers 26 to configure a negotiation profile for each that automates much of the negotiation process referred to the “DoneDeal Making System.” Once configured, the provider 26 then has a number of options of how to market their services. Using the Provider Marketing sub-system 52, providers 54 can simply list and wait to be found, send their offers to users 12 of the system that have stated an interest in similar services or providers, or send their offer to the general public. When consumers 12 respond to their offers they also have their own version of the DoneDealDashboard 48 that enables them to manage and respond to requests and manage the offers they have made. Once again, once there is an agreement between provider 26 and consumer 12, The DoneDealDocument 34, a contract with contact information and service details is emailed to both parties by the system. After services are rendered the provider 26 is prompted to advise if the patient showed up or not and may be asked to verify the patient's review through the Offering Specific Verified Review system (OSVR.) 44. Finally, the provider 26 is encouraged to share the offerings and reviews through social media and other portals the system 10 is integrated with.

The final users of the system to describe are the moderators and administrators. While most of the processes are automated through the system 10, oversight by moderators and administrators is required in certain circumstances. Management reports for providers are also required. Utilizing novel Provider Pricing, Provider Quality, Provider Deal Making, Consumer Behavior, and Customer Quality reports and indicators not available elsewhere, the system 10 enables a new way to understand consumer and provider behavior and metrics that will add much to the management of healthcare decision making. These data and reports are also considered marketable and valuable aspects of the system in addition to aiding decision making for providers 26, consumers 12, and administrators of the system 10.

By means of these innovations the system brings service provider/consumer relationship building to a new level. No longer does one need to negotiate service offerings and prices in a blind, one-on-one format on the phone or in person. Individuals and providers can conduct a dozen such negotiations simultaneously with access to all pertinent information all in one place. The example described is for one of the most complex transaction categories, those of the healthcare industry, but the system has been designed to be utilized for any complex service industry from carpenters to attorneys.

The system is written in a web application framework, such as using the Ruby on Rails web application framework, and built with a programming language, such as the Ruby programming language, in a managed cloud computing environment, to provide a highly available, scalable, secure, and reliable, application platform. End users, both service providers 26 and customers 12, are required to utilize the software 22 and hardware 20 controlled by the system 10 to use the system 10. There is no way to utilize the system 10 without the complex databases and software installed on the servers (hardware) as they have been configured and designed.

The searching for offers and requests for services of the present invention is now described. A key component and the entry point to the system is the search functionality. Utilizing existing open source tools a unique matching system has been developed for services. In the first implementation, that of for healthcare, this means that keywords from offers are translated and matched through a terminology translation database 24 that can connect a symptom to a treatment and a service to an ailment. This by no means is intended to replace the expert service provider's role, it merely helps providers 26 and consumers 12 connect to each other.

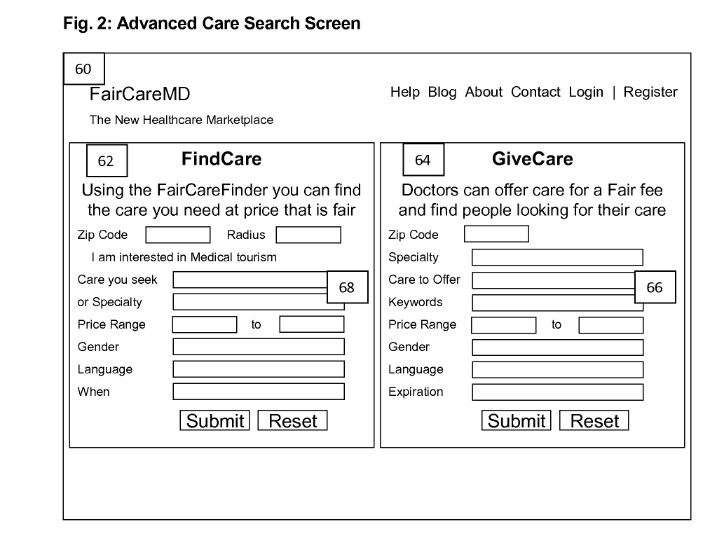

The search interface is described where the search for care is initiated in either basic or advanced form. The advanced form 60 is shown in FIG. 2 where patients 12 and providers 26 can search for each other based on many criteria: specialty, offering, price, location, gender, languages, timing, and free-form text searches for keywords in offers. The providers 26 search on the GiveCare side 64 (right side of FIG. 2) and input the provider criteria 66 and the patients 12 search on the FindCare side 62 (left side.) and input patient criteria 68.

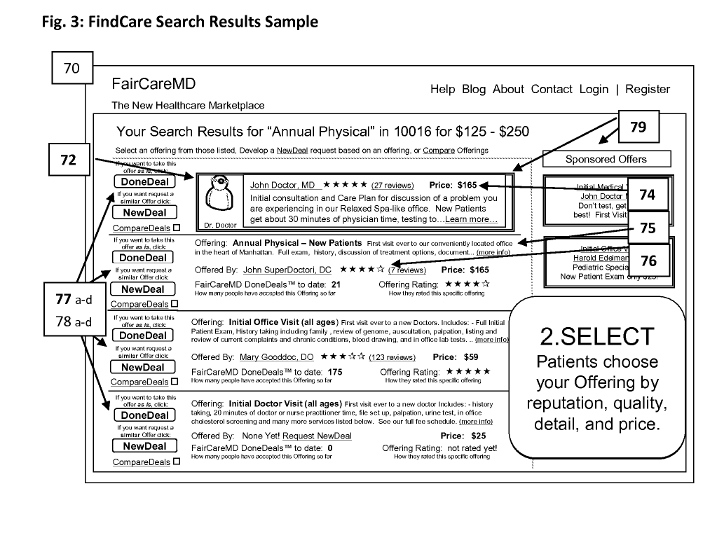

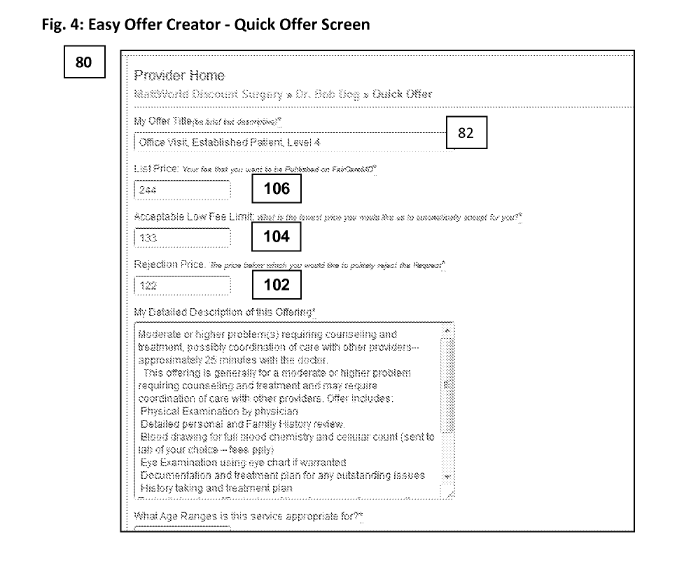

Referring to FIG. 3, the search results view is novel in that it shows information not available previously regarding a provider's Quality, Ratings, Price, Location, and Specific Service Offerings and allows comparisons all on one page from one system. FIG. 3 shows what a typical result 70 looks like, as a plurality of offerings 75 are shown. Note the Provider's Image 72, Price 74, and Ratings 76 are all clearly visible and integrated with appropriate service offerings 75 with actual prices. This is possible due to three factors: 1) the system limits who is permitted to make offers in the system and thus increases the relevance of search results and 2) the system's unique medical search algorithm matches patient requests with provider offerings as described above and 3) the Easy Offering Creator (See FIG. 4) that facilitates customized offerings 75 that can be easily related back to a similar offering table.

On the search results screen 70 depicted in FIG. 3 there are a number of notable elements that display how the invention 10 works. The patient 12 or provider 26 can click on the DoneDeal buttons 77a-d or NewDeal buttons 78a-d on the side of each offer 75. These lead in to the DoneDeal making process (See FIG. 1) as either accepted deals (DoneDeals) 34 or requests for changes to the Deal (NewDeals) 38 as described later. Also note the sponsored offers 79 as providers 26 have the ability with this invention 10 to sponsor their listing to patients 12 searching for a particular service offering. For example, a radiologist could pay extra to get to the top of search in a particular zip code whenever a patient seeks an MRI. This has not previously existed where the result is a specific service offering.

Next, the Easy Offering and Request Creator of the present invention 10 is described with reference to FIG. 1 and FIG. 4. The key to the system 10 is the allowance of both sides to edit, create, and send service offerings and service requests to each other that include as much detail about the service as desired, links to more information, prices, provider biographies, service locations, references, and limited time frames for response. The respondent can then accept, reject, or counter the offer or request until the two parties 12 and 26 agree upon a fair price and a service offering detail for services they want to give or receive. In order to automate and facilitate this process, providers 26 of services are guided in the creation of offers that are unique, yet standardized. As time goes on the variability of offers will grow but the referential nature of the offering generation system allows a traceable path to the origination of an offer as well as a relational database link 24 that facilitates search and makes it more relevant. Depicted in FIG. 4, can be seen the initial data that an offering is loaded with. A typical screen shot of the Easy Offer and Request Creator 80 is shown in FIG. 4 with provider offer information 82 entered by provider 26. The offer information 82 may include items such as title, price of the offer, fee limits, rejection price, description of the offer, etc. The provider 26 can select from various menus, clone existing offers, or create a brand new offer from scratch but the Quick Offer screen 80 makes it easy to create offers which tie in to the search and other functions.

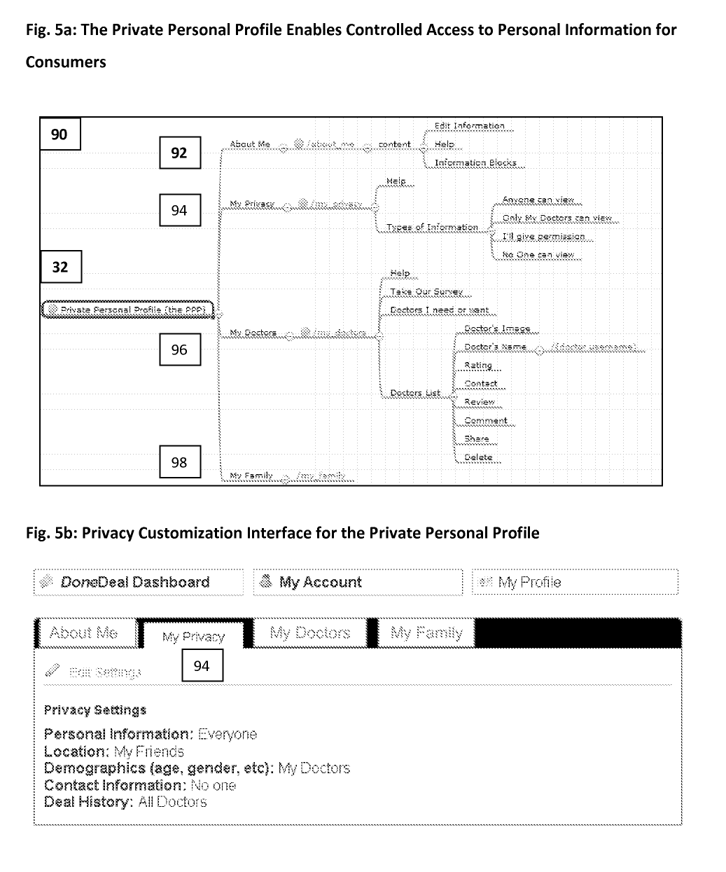

In order to protect privacy issues, the system 10 includes a new solution for privacy called “The Private Personal Profile” 32 as illustrated in FIGS. 5a and 5b and incorporated in the system 10, as shown in FIG. 1. Privacy is a great concern for consumers of many varieties and especially patients. Healthcare providers also need to follow certain regulations that safeguard patient information. FIG. 5a illustrates a schematic outline 90 of the Private Personal Profile 32 and the information contained within the profile which accomplishes the goal of privacy. As the schematic 90 illustrates, the profile 32 contains items such as patient information 92 about a patient/user 12, specific privacy control features 94, doctor information 96, and additional information about family 98. The described system respects personal privacy in several ways. First, it does not require actual patient names and highly encourages the use of pseudonyms. Second, by means of the “Private Personal Profile” or PPP 32, a user 12 may elect to share his or her information selectively based on which stage of relationship building with a provider 26 he or she is at. As seen in FIG. 5b, the PPP 32 allows the patient choices such as releasing no information; basic demographic information such as age and gender; full demographics; provider specific data; and finally full data access. By maintaining a privacy profile 32 for each type of interaction and also down to the individual provider level 96, patients 12 have complete control of their information release with similar corresponding choices (no information; basic demographic information such as age and gender; full demographics; provider specific data; and full data access) for each category (92, 94, 96, and 98). The third way to protect patient data is by using high encryption software that prevents unauthorized access to our systems. In combination with the limited release of this data based upon developing provider relationships, this is a system that is unique and serves the interests of consumers in many fields, not just patients.

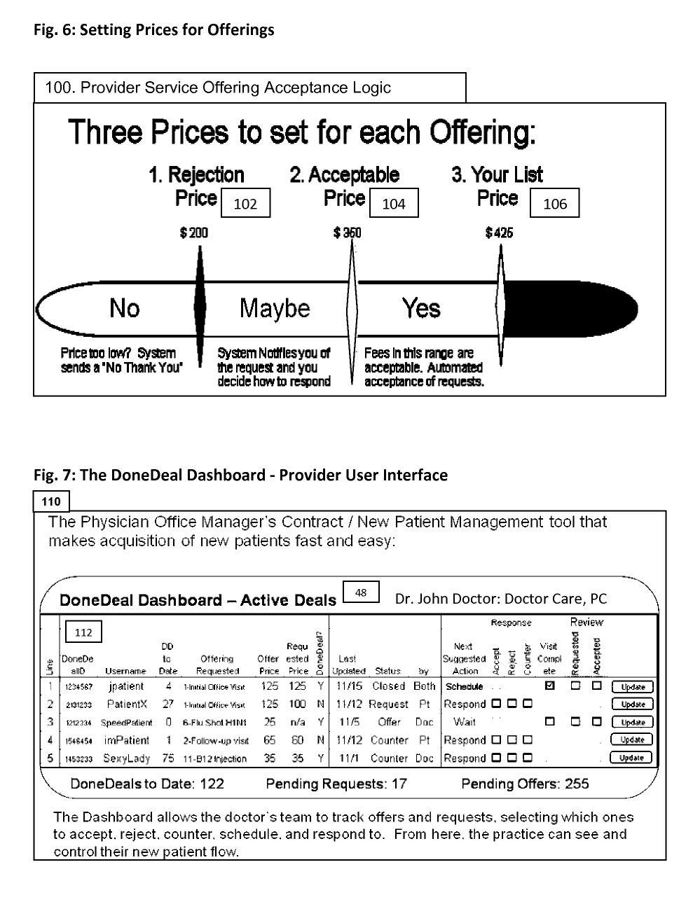

The system of the present invention 10 includes a single bid negotiating and “Three Price System” for negotiating mutually fair healthcare contracts between two buyers and sellers of services as illustrated in FIG. 6. Pricing in various industries, especially healthcare, is a matter of great concern for regulatory and statutory reasons. For Medical and Dental Providers, based on the rules of third party payers such as the U.S. government via the Centers for Medicaid and Medicare Services (CMS) and insurance company agreements, certain rules on pricing must be respected otherwise the provider 26 could be subject to penalties as severe as losing their license and being unable to practice their trade. For this reason the approach to creating a price matching and negotiation system for healthcare is particularly challenging. In order to satisfy the needs to allow provider 26 pricing flexibility, increase pricing transparency, and developing a way to work out reasonable prices for both sides of the transaction, the described system 10 required the development of a three price system 100 with automated and facilitated communications. This module of the system 10 allows providers 26 and prospective patients 12 to agree on prices in an automated format that respects the needs of healthcare professionals and prevents violation of pre-existing and even future laws and regulations. This module is also easily applicable and highly useful for utilization in other industries.

The pricing and negotiation sub-system achieves the goals of fairness, privacy, and transparency through three methods, which, when combined, create a novel approach to price negotiations. First, each provider service offering allows the provider to set three prices: a list price 106, a low acceptable limit 104, and a rejection price 106 as can be noted in FIG. 4 and is further detailed in FIG. 6. Secondly, the service offerings are completely customizable and are not required to be based on existing coding terminology. This allows providers to create offerings that are how they want to offer services, not based on an externally applied or regulated system. Each provider 26 can write his or her own service offerings and practice medicine how they believe is best. In fact, by allowing the providers to clone offers that have become popular on the system we are encouraging mutation and evolution of the healthcare delivery model in ways that providers 26 and patients 12 will appreciate and may vastly improve access and quality of care. Third, by displaying only the list price 106 to consumers and allowing only one price request per consumer per offering we create an environment where fair prices are favored and reliably produced. Patients 12 who perpetually request prices that are too low will quickly learn that this strategy will not be effective. FIG. 6 shows how the prices relate to one another. The service provider 26 sets a list price 106, an acceptable price 104 and a rejection price 102. Prices which fall in the range of the list price 106 and the acceptable price 104 are acceptable to the provider 26 and generate an automated acceptance of requests. When price request from patient 12 falls in the range of the acceptable price 104 and the rejection price 102, the three price system 100 notifies the provider 26 of the price request and the provider 26 chooses how to respond. If the price request is below the rejection price 102, the system sends an automatic “no thank you” type response rejecting the price request. The three price system 100 both improves transparency and respects the privacy of medical pricing from providers 26 of healthcare services with the final result being the development of pricing that is considered fair and acceptable to both sides of any given deal.

With the present invention, there is provided a deal management system 46, referred to as the “DoneDeaDashboard.” A key integrated component of the described system is in the Provider/Consumer (patient in the described case) communications system 48 called the “Done Deal Dashboard” or “DDD.” As shown in FIG. 7, there is shown a detailed display 110 of the provider user interface—Done Deal Dashboard 48. This management tool includes significant offer and request information, indicated generally by reference number 112. This dashboard information may include the Done Deal identification number, the patient name/username, offer request, offer price/requested price, agreed/DoneDeal status, updates, action items, responses and reviews. Through the DDD 48, providers 26 and consumers 12 can not only execute negotiations for services and prices but also communicate in a structured format that helps them build long term relationships while respecting the privacy of both parties. The DDD 48 forces consumers 12 to respect the provider's time and limits the provider's exposure to emails from the general public. Health information is among the most sought after online and direct access to a provider 26 exposes the doctor 26 to an overload of communications resulting in a failure of any messages to get through. Providers also are subject to greater time constraints than most professions, further increasing the need to automate communications as much as possible. Finally, maintaining a positive relationship with the general public is also important to providers 26 so ignoring requests is not considered acceptable. The Dashboard 48 allows the doctor's team 26 to track offers and requests, selecting which ones to accept, reject, counter, schedule, and respond to. From the DDD 48, the practice can see and control their new patient flow.

The DDD 48 enables all these actions by means of a simple interface that allows the provider 26 or his or her office staff to communicate directly with patients in a bi-directional manner without ever giving out email addresses and using automatically generated responses. Requests from patients 12 for changes in services, prices, locations, or providers 26 based upon existing or new offers are called “NewDeals”. NewDeals are queued and/or responded to in the DDD 48 based upon criteria the provider 26 sets.

For example, if a consumer 12 changes the text of an offering, perhaps asking for an eye exam to be added to their child's annual physical, the communication will be indicated as a “Service Change Request” on the Provider's DDD 48. The patient also has their own DDD 48 where this same request appears as an hourglass with a number next to it, indicating that they are waiting a defined amount of time until the provider 26 (generally a doctor in this description) gets back to them. If the provider 26 does not respond then the system automatically sends a rejection and releases the patient 12 to make additional requests.

A second scenario is one where the patient 12 changes only the price. If the price is below the rejection price 102 the patient 12 is automatically notified with a standard “No Thank You” letter that the provider 26 can configure. If it is above the rejection price 102 but below the low acceptable limit 104 the patient 12 is given a customized message such as, “Thank you but please wait 1 day for a response”. Finally, if the price request is above the low acceptable limit 104 then it accepts the price and moves the status to “DoneDeal.”

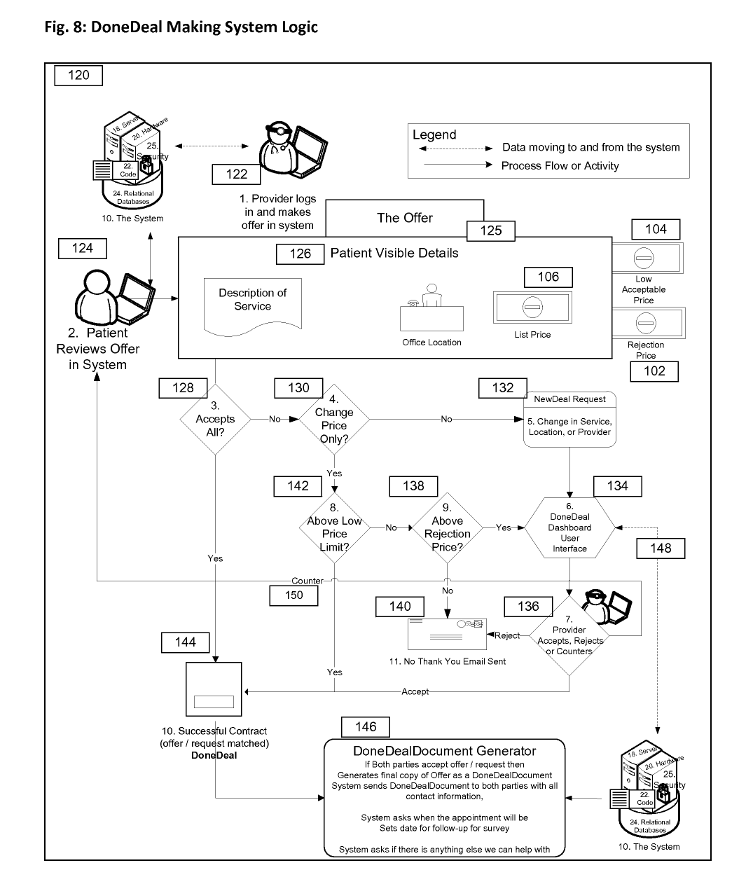

With reference to FIG. 8, the flow and logic of the DoneDeal Making system 120 is described in detail. The provider 26 logs into the system 10 and configures an offering for services in the system 10. (Step 122). The patient 12 then reviews the offer in the system (Step 124). The offer 125 includes patient visible details 126, such as the description of the service, the provider 26, location, and list price 106, with the rejection price 102 and low acceptable price 104 of the offer 125 hidden from a patient's view. The patient 12 then decides whether to accept all the terms of the offer 125 (Step 128). If the patient 12 responds affirmatively, then a successful contract is made with a resulting DoneDeal (Step 144). If the patient 12 does not accept all terms in Step 128, then the patient 12 is queried regarding a change of price only. (Step 130). If the answer is no, then a New Deal Request is made (Step 132), which might include a change in service, location or provider. From here, the request is sent to the DoneDeal Dashboard user interface (Step 134) and then to the provider to accept, reject or counter (Step 136), described in more detail below. If the answer from the patient 12 is yes (to change price only in Step 130), then the system verifies if the price request submitted by the patient 12 is above the low acceptable price 104 (Step 142). If the price is above the limit 104, then a successful contract is made with the offer and request matching—a DoneDeal (Step 144). If the price is not above the acceptable low limit 104, then the system checks if the price is above the offer rejection price 102 (Step 138). A negative response here results in a “no thank you” reply sent back to the patient 12 (Step 140). If the patient's price is above the rejection price 102, then the system sends the request to the Done Deal Dashboard user interface (Step 134) which the provider 26 may then accept, reject or counter (Step 136). A rejection by the provider 26 in Step 136 results in the “no thank you” response sent to patient 12 (Step 140). An acceptance of the price by the provider 26 in Step 136 results in a Done Deal successful contract (Step 144). A counter proposal by the provider 26 in Step 136 sends the counter-offer back to the patient 12 as indicated by arrow 150 to repeat the decision process.

Included with the process of the Done Deal making system flow and logic 120 is the DoneDeal Document generator 146 which is sent from the system 10 and storage features of the system, ie. hardware 20, databases 24, servers 18, and software 22. If both parties accept the offer and request, then the system 10 generates a final copy of the offer as a DoneDeal document and sends it to both parties with all the contact information. The system 10 inquires when the appointment would be made or sets a date for follow up surveys.

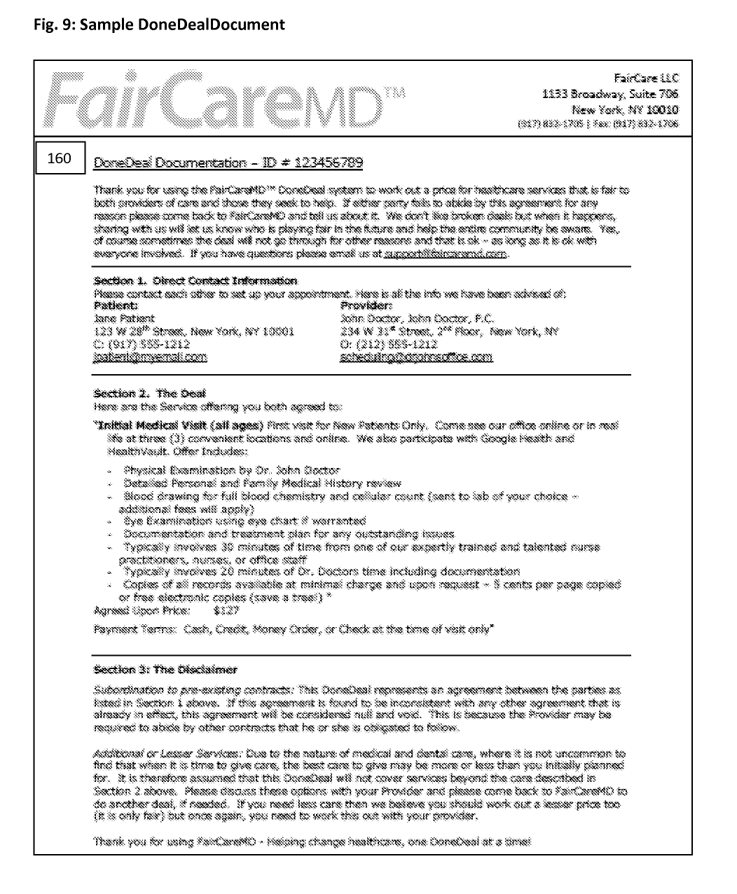

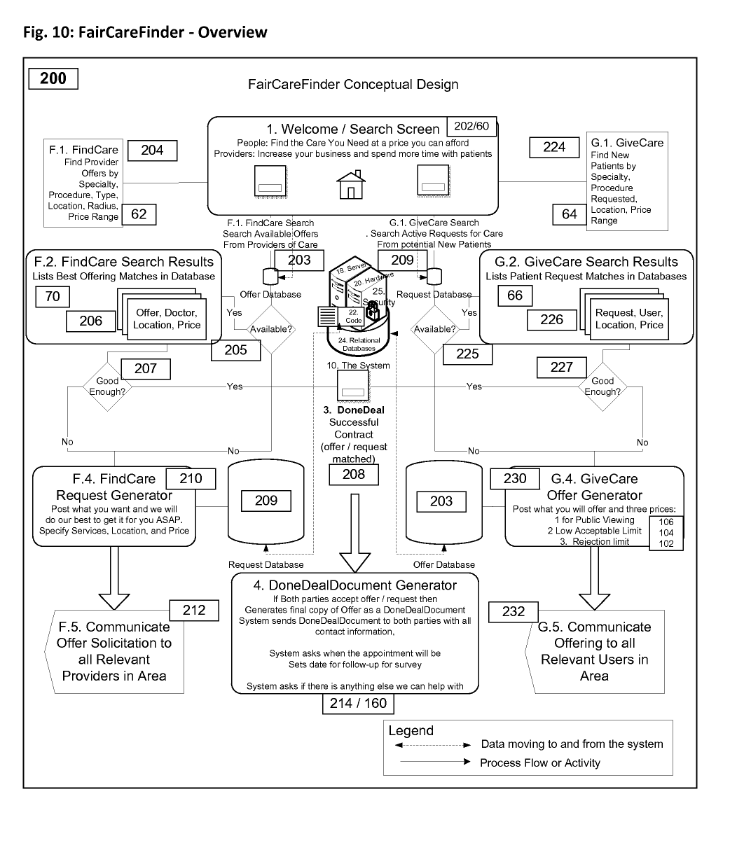

The present invention 10 includes automated healthcare contracting, a feature known as “DoneDealDocuments” 160 as illustrated in FIG. 9. Successful matches between provider offers and consumer requests, called DoneDeals, require publication and documentation for execution. The system achieves this through “DoneDealDocuments” 160 which are automatically generated contracts for services written to specifically be sub-ordinate to provider agreements with government and other payers. If an existing contract prevents the execution of the services in the agreement for the price stated then the provider 26 must revert to the senior agreement. The system 10 generates these agreements by a unique contracting system that records electronic approvals and assembles the agreement from three components: 1) available demographic information in the system from both parties, 2) the agreed upon service description with a quoted price and 3) standard text that indicates limited nature of contract for both parties as well as basic instructions. Due to the likelihood that services required differ from services contracted for, especially where matters of health are concerned, this system is a novel and effective solution for providers 26 of services such as healthcare care and the people they serve.

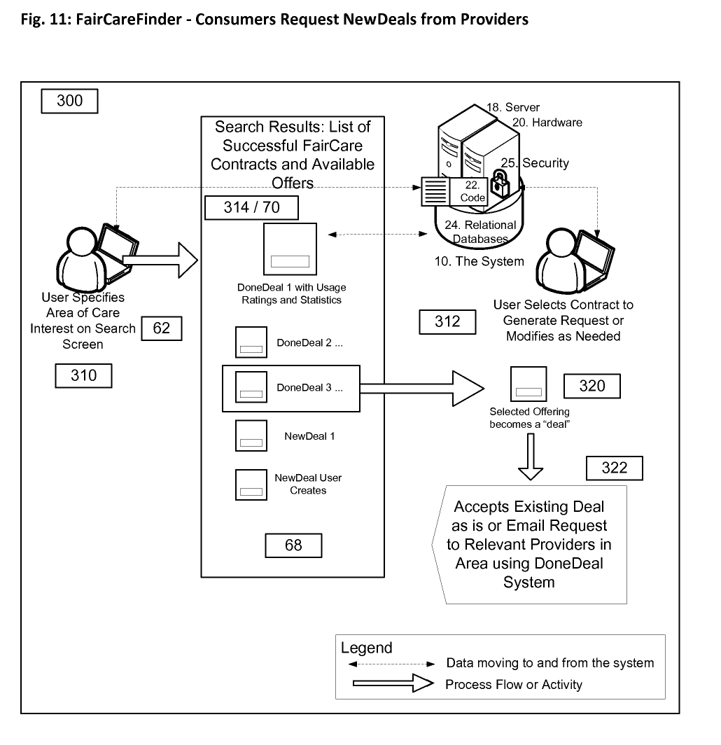

As shown by FIG. 10, the present invention has a services marketing system 200, referred to as the “FairCareFinder” which is a search-based matching system for providers 26 to connect to prospective consumers 12. With over 80% of Americans searching for health information online and more people shopping for care, there is a need for a better way to shop for care that allows patients to see quality, price, location, training, reviews, and actual service offering descriptions all in one place. A typical search engine does not satisfy this need for several reasons: detailed service offering and pricing information is not available, without our system of developing related service offerings it is not possible to get a cross-referenced indexed dataset, and there presently is no ability for a provider 26 to control what content is available regarding his or her services online in a filtered format except on their own website. Conversely, there is no present system utility for a provider 26 to search for who is searching for their services. The system's marketing module called the “FairCareFinder” and depicted in FIG. 10 offers a bi-directional solution for medical marketing that changes the paradigm of how providers 26 and consumers 12 find each other and begin their relationships. The overall marketing system 200 as described is designed to help providers 26 and consumers 12 to further develop relationships, agree on services, and maintain relationships with one another.

Current medical marketing methods are largely uni-directional (from the provider) and non-permission based. The result is a very expensive way to get new patients for doctors with literally tons of advertisements being sent to people who are not interested in the services. Outdoor, television, online, and radio advertising also add greatly to the cost of care and deliver a very low return on investment. New online and off-line permission-based marketing techniques gather interested consumers and then target ads directly to them. The FairCareFinder sub-system 200 described herein is permission-based, enabling new connections between providers 26 and consumer 12 seeking each other matched by location, price, quality, and service offerings or requests.

The flow diagram in FIG. 10 is the overall model of how the FairCareFinder 200 operates. The patient 12 or provider 26 arrives at the website (step 202) and searches on what he or she is looking for, either to FindCare 62 or to GiveCare 64 as displayed in FIG. 2. Users can search with a simple text string and our databases will find the best matches available. Alternatively patients or provider can perform an advanced search across many fields to find the Provider or new patients that they seek respectively.

Referring first to the patient side of the process in FIG. 10 (FindCare), there is shown the initial search for care at the welcome screen (Step 202), where the patient 12 searches available offers of providers by factors such as specialty, procedure, type, location, radius, and price range (Step 204). The offers are stored at the offer database 203 in connection with the storage servers 18 and hardware 20. The FindCare search results are generated (step 206) from the available 205 best offering matches in the database 203. If the user finds an offer which is satisfactory 207, the user selects the offer and a successful contract is made by the matching offer and request, i.e. a Done Deal. 208 and brings the parties to the DoneDealDocument generator (step 214) to provide the DoneDealDocument with the appropriate information on the contract, i.e. date, location, follow up date for survey/review. If the offer database 203 determines that there is no matching offer available, or the search results returned are not satisfactory to the user, then the system allows the user to go to the FindCare Request generator (step 210). Here, the user 12 makes their desired request and the system does the best to locate it quickly. The factors of a request may include such items as specialty services, location, and price. The requests are sent to the request database 209 for access by the system's servers, memory and relational data base to communicate and interrelate with providers 26 searches and offers. From the request generator in step 210, the user communicates their offer solicitation to all relevant providers in an area. (Step 212).

From the provider side (GiveCare) of the process in FIG. 10, there is shown the initial offer for patients and search for patients at the welcome screen (Step 202), where the provider 26 enters available offers for patients by factors such as specialty, procedure, type, location, radius, and price range (Step 224). The patient's requests are stored at the request database 209 in connection with the storage servers 18 and hardware 20 of the system 10. The GiveCare search results are generated (step 226) from the available 225 best request matches in the database 209. If the provider finds a request which is satisfactory 227, the provider 26 selects the request and a successful contract is made by the matching request and offer, i.e. a Done Deal 208 and this brings the parties to the DoneDealDocument generator (step 214) to provide the DoneDealDocument with the appropriate information on the contract, i.e. date, location, follow up date for survey/review. If the request database 209 determines that there is no matching request available, or the search results returned are not satisfactory 227 to the provider, then the system 10 allows the provider to go to the GiveCare Offer generator (step 230). Here, the provider 12 makes the desired offer and the three prices of a public list price 106, low acceptable limit price 104, and a rejection limit price 102 (See FIG. 6). The offers are sent to the offer database 203 for access by the system's servers, memory and relational data base to communicate and interrelate with patient's 26 searches and requests. From the offer generator in step 230, the provider communicates their offering to all relevant patients/users 26 in an area. (Step 232).

The key to the matching system is the request/offer search engine that compares requests and offers as discussed above. To summarize briefly, the system matches consumer 12 requests and provider offers by mapping the search string to common diagnoses, treatments, symptoms, or related terminology to derive a best match to offers or requests. These data, in addition to simple search parameters such as zip code, provider languages, gender, specialty, and prices, result in a selection of best matches in the databases for a particular search request.

The results of this search, as depicted for patients searching for providers in FIG. 3 allow the consumer to research the Providers and offering in great detail. The provider profiles show not only physician details but also a great many details about the practice, quality, service offering, location, and links to up to 10 other websites for each provider. This is unique in the industry that values inbound links over consumer usability and provider data centralization.

The patient 12 can then accept or modify the offering as shown resulting in either a DoneDeal or a NewDeal respectively. The processing of these system requests is detailed in FIG. 7 and FIG. 8 and described above with reference to those figures.

In the event that no match is found the user is prompted to add a request or offer to the system which is then, in turn, sent to local providers or patients who are seeking such patients or Providers. In this mirror-image relationship-building system we create a unique marketplace function that is novel and will satisfy the needs of both people seeking Providers and Providers seeking people who need their care. These scenarios are detailed in the subsequent sections.

1. Patients Seeking Offers without Providers

As the system has over 60,000 types of services to choose from, it is expected that patients will often find procedures that have been described but have not been offered by any providers in the system yet. Here, through a unique system show in FIG. 11, patients are allowed to request a “NewDeal” from a list of appropriate providers in the system. In FIG. 11 there is shown the Consumer's Request NewDeals from Provider process, indicated generally as 300. Included in this process 300, the user specifies an area of care interest (Step 310) as a first step. From this, the user 12 reviews a list of successful contracts and offers stored on the system 10 (Step 314). The user 12 selects a contract to generate requests or modifies as needed (Step 312). From the list of contracts and available offers the user selects an existing deal as is (Step 320) or alternatively, the user emails a request to relevant providers 26 using the DoneDeal system (Step 322). For example, if a patient needs Allergy Testing but there are no Allergists offering the tests in the system, the FairCareFinder allows the patient 12 to send her request to local providers 26 who are listed as Allergists. These “NewDeal” requests are sent via fax, email or telephone depending on the contact information available in the system (Step 322). It is expected that through this system FairCareMD will spread with a viral growth pattern until every provider who would be interested in FairCareMD patients is finding new patients through FairCareMD.

2. Providers Seeking Patients

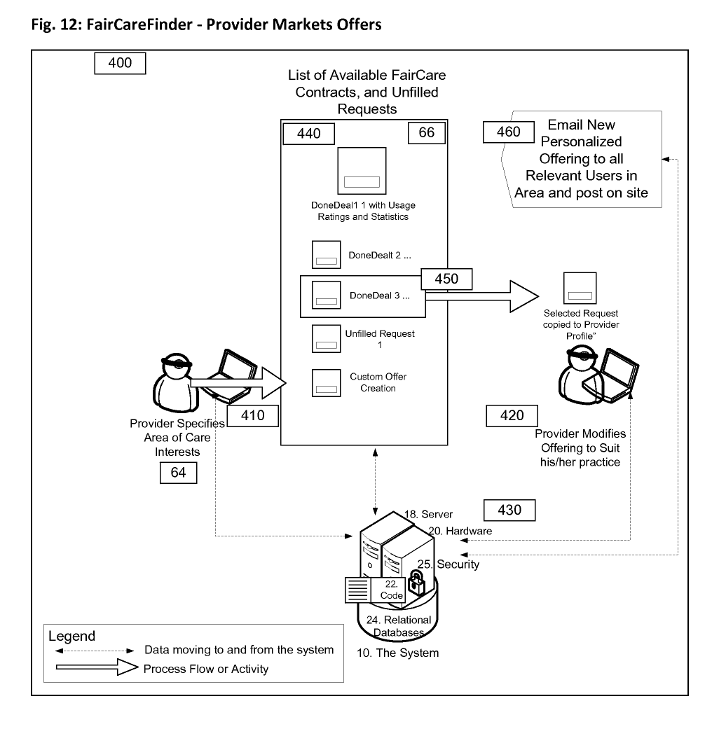

As depicted in FIG. 12, providers 26 may also search for patients both in the FairCareMD databases and outside the system that seek their care. In FIG. 12 there is shown the FairCare Provider markets and offering system 400. The provider 26 specifies an area of care (Step 410) by accessing the system database (Step 430) and the provider 26 reviews a list of available FairCare contracts and unfilled requests (Step 440). The provider may wish to modify the offerings available to suit his or her practice (Step 420) and from this list in Step 440 the provider 26 selects an offering and may modify accordingly (Step 450). The new personalized offering is then sent by email to all relevant users 12 in the area and posted on the site (Step 460).

By searching internal databases the system is utilizing permission marketing where patients specifically opt-in to be contacted with offers from different providers 26 by specialty. Providers can then send offering specific to the individual 12 based upon criteria. For example, if a Neurologist or Radiologist wants to offer a fair price for aneurysm screening for all new patients for $700 to the first ten people to respond he or she can do that through the system. First the provider crafts an offer with specific details about services, pricing, providers, and location. Then they would search for patients. Finally they would send the offer to patients who have specifically stated that they do not have a neurologist they are seeing AND want to be contacted with special offers. (Step 460). Responses are managed through the DoneDealDashboard as described previously. A second non-permission based system allows providers to generate marketing programs based on offers and send them via electronic and paper formats to selected members of the public based upon demographic criteria including age, gender, geography, home ownership, insurance status, and household income.

The Patient Selection Criteria for Providers with the present invention is now described. A novel set of information is available to Providers selecting patients on FairCareMD. This includes not only basic demographic information but also social media metrics, no show history, and review patterns. A listing of criteria available to the provider is the table below. Note, however, that name, contact, and medical information is entirely up to the patient.

| | |
|---|---|
| Demographics | Age, Gender, Zip Code, self rated fitness and health |
| | level, family size |
| Social Media | Number of Twitter Followers, Number of Facebook |
| Metrics | Friends, LinkedIn Connections, Foursquare metrics, |
| | other social media metrics as they become available |
| FairCareMD | Average Rating, Frequency of Moderated comments, |
| Metrics | Frequency of No Shows, Number of DoneDeals, |
| | number of NewDeal requests, Average Price Paid as |
| | a percent of list price |

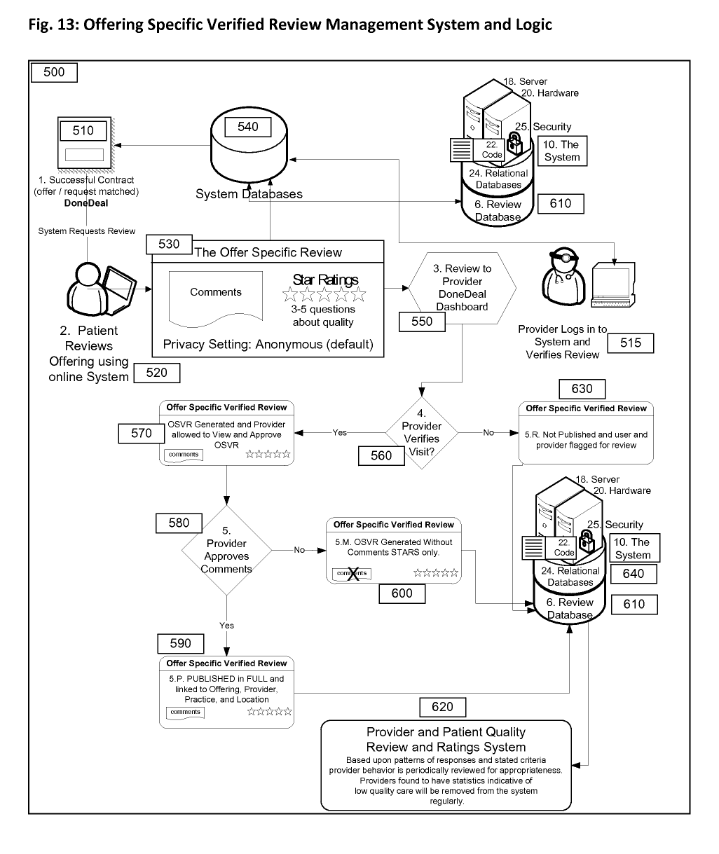

The present invention includes an “Offering Specific Verified Review System,” as described herein and also with reference to FIG. 13. While reviews of medical providers abound, reviews specific to individual service offerings are not currently available online. Additionally, readers of provider reviews have no way of knowing if the reviews were from actual patients and lack credibility due to how they are collected. The result is a non-specific, unverified review that does not help people decide which service provider to choose, hence the existing systems are not well regarded nor are they well adopted. For example, the best orthopedic surgeon for shoulders may not be great at knees and there is no where to find this information presently. Local providers in the same specialty generally know who the better practitioners are but the general public and even other providers have no way to research or even review a provider's skill by specific procedure.

With reference to FIG. 13, there is shown the Offering Specific Verified Review Management System Process 500. The system 10 and storage features (Step 505) relay to the system database 540 the information regarding a successful contract, i.e., DoneDeal (Step 510). The patient reviews the offering using the online system (Step 520) and within the system there is the Offering Specific Review, OSR, 530 which allows for comments and ratings by the patient. This information is sent back to the system database 540 and also the review is sent to the provider DoneDeal dashboard (Step 550). From here, the provider verifies the visit (Step 560). If the visit is verified (yes), the Offering Specific Verified Review, “OSVR”, is generated and the provider 26 is allowed to review and approve the OSVR (Step 570). Next, the provider 26 approves the comments (Step 580). If the comments are approved, then the Offering Specific Review is published in full and linked to the offering, provider, practice, and location (Step 590) and is then relayed for storage in a review database (Step 610). If however, the provider does not approve comments in Step 580, then the OSVR is generated without comments but only with the ratings. (Step 600) This information is then sent to storage in a review data base (Step 610) which is all maintained by the system 10 (Step 640).

Referring back to the provider verification of Step 560, if the provider does not verify the visit, the OSVR is not published and the user and provider are flagged for review (Step 630). This information is likewise sent to storage in the review database (Step 610). From the review database in storage, the Provider and Patient Quality Review and Ratings system (Step 620) is generated. With this, the patterns of responses and stated criteria of provider behavior are periodically reviewed for appropriateness. Providers found to have statistics indicative of low quality care will be removed from the system regularly.

As described above, the invention for Offering Specific Verified Reviews (OSVRs) and the associated process and database allows patients to make reviews of their doctors for very specific services, those that they contracted for through FairCareMD. Providers are also allowed to moderate out the comments of a review in up to 25% of all reviews. They cannot remove the “star” ratings, but they can remove the inappropriate comments as they see fit for up to one in four reviews.

The reviews consist of five to seven (5-7) questions and two free form text entry fields, one for public comments for publication upon approval and one for private communications with the provider (not for publication.) The responses to the questions are depicted as stars and have five levels. FIG. 13 details the mechanics of the system and it is briefly described here.

Once a DoneDeal has been made, the system emails the patient up to three times, requesting a review of the provider's offering. The patient logs in to the secure system and answers the review questions about the specific DoneDeal. The system assumes the patient would like to remain anonymous but allows the Provider to identify them by username. The review is then sent to the Provider for verification and displays as such on the Provider's DoneDealDashboard.

First, the provider 26 or his staff must verify that the patient was seen and second that they approve the publication of the review. The provider cannot view the review until after they have verified that the patient was seen or not. (Step 560). This simple approach ensures providers do not try to erroneously claim a patient was not seen by them if the review was bad and adds validity to the described review system. Note that even if the patient has indicated that they wish to remain anonymous on publication and could have their name removed, the provider will be able to determine who the reviewer was, if in fact they were seen in his or her office. There is no need for real names, so it is possible that they will not know actual names affording a potential level of privacy that is not possible elsewhere. Once verified, the Provider is allowed to view the review and will need to accept it for publication or reject it. The response will be recorded and the resulting review will be fully or partially published. (Step 590 or 600).

Periodic reviews of the data results in termination of subscriptions for Providers found to be rejecting greater than 25% of reviews though this is subject to review since doctors who do treat patients known to be problematic will be shown leniency. Providers who consistently suppress reviews are removed from the system in order to maintain an acceptable level of Provider quality. In either case, the review is to be posted to the Provider's profile and tally in to his or her metrics in The System and published on the site. Reviews and Review Summaries may also be shared on the provider's various fan pages and can be tweeted through any of several interfaces with social media companies such as Twitter and Facebook.

Social media and many service industries, especially healthcare, are not always a good match. For most people and most procedures, health information is not something to be shared. The system described here has links to and from social media sites that respect this fact. In all cases reviews and offerings are private and anonymous unless the Patient has approved the publication. The default setting for review publication is anonymous, as indicated previously. The fact that the system requires a DoneDeal prior to making reviews ensures that the patient is validated, devaluing the need for a user to associate with the review.

The present invention also allows for a provider and patient quality review and ratings system. As referred to above, there are many novel reporting criteria and data sets that the system makes available to users of the system and the administrators of the system. These data are not limited to the no show rate of patients and the review response behavior of Providers but also include quality and cost metrics previously not available. Because the system captures and records information on a transactional level not available elsewhere numerous novel reports have been developed using this data that is highly marketable. The reporting system itself is an ad hoc relational database integrated into the system from initial design stages. It is an essential component of the system and is included in this application.

Another novel aspect of the system of the present invention is the Search Engine Optimization strategy. Most sites of this nature generate hundreds of thousands of static pages with rich content for search engines to crawl and index. These data are only limited by the relevant content they have. For example, a physician directory will have a page for every provider and adjacent zip code combination in their database. So 100,000 providers×5 zip codes×2 reviews each would equate to a million static pages based upon the three dimensional data set of Providers, Zip Codes, and reviews. In our system there exists a fourth dimension to the data that will enable our systems to capture greater SEO, relevance, and page rank than our competitors for the top position in search. The fourth dimension is offerings. The same million pages the physician directory site example given would be multiplied by the number of specific offers per provider, a number that is about 7 in our current user base. This seven million pages then would have about seven times the probability of being relevant to search engines, especially when searching for specific services.

A second SEO unique aspect of our database design includes is the development of what we call PGC, short for Provider Generated Content. PGC is particularly important to search engines because it allows the doctors to create their own great original content that is full of relevant key words and will be highly content rich.

There are many ways that SEO strategies change daily but rich content and sheer quantity of unique relevant pages are two ways that do not change. Our novel approach to the design of this system will make our sites based on this technology uniquely advantaged in terms of SEO.

What is claimed is:

1. A system comprising:
a first computer device with a first user communicating with a second computing device and a first service provider through a server; said first user selectively controlling the privacy of said communication;
the first computer device receiving a user pricing request for services from the first user;
a data storage device associated with said server having a plurality of provider offers from a plurality of service providers;
each of said plurality of provider offers having a list price value, a low acceptable price value less than said list price, and a rejection price value less than said low acceptance price value;
said first user price request having a value greater than or equal to said low acceptance price value of at least one of said plurality of service providers to return at least one matching provider offer to said first user;
the first user selecting one of said at least one matching provider offer.

2. A computer implemented method having a first user and a first computing device, the method comprising the steps of:
communicating with a second computing device and a first service provider through a server, where said first user selectively controls the privacy of the communication;
receiving a user pricing request for services from the first user at the first computing device;
associating a data storage device with said server;
communicating said first user price request with said data storage device, where said data storage device has a plurality of provider offers from a plurality of service providers; each of said plurality of provider offers having a list price value, a low acceptable price value less than said list price, and a rejection price value less than said low acceptance price value;
returning at least one matching provider offer to said first user when said first user price request has a value greater than or equal to said low acceptance price value of at least one of said plurality of provider offers; and
selecting one of said at least one matching provider offers by said first user to initiate a user and service provider relationship.
